(19) United States
(12) Patent Application Publication
(10) Pub. No.: US 2025/0254760 A1
(43) Pub. Date: Aug. 7, 2025

(54) COOKING APPLIANCE, CONTROL METHOD AND DEVICE THEREOF, ELECTRONIC DEVICE AND COMPUTER-READABLE STORAGE MEDIUM

(71) Applicant: GUANGDONG MIDEA KITCHEN APPLIANCES MANUFACTURING CO., LTD., FOSHAN (CN)

(72) Inventors: Liang LI, FOSHAN (CN); Yan CHENG, FOSHAN (CN); Zhifei ZHU, FOSHAN (CN)

(21) Appl. No.: 19/086,089

(22) Filed: Mar. 20, 2025

(30) Foreign Application Priority Data
Feb. 4, 2024 (CN) 202410160766.X

(51) Int. Cl. H05B 1/02; F24C 7/02; F24C 7/08

(52) U.S. Cl. CPC H05B 1/0263; F24C 7/02; F24C 7/087

(57) ABSTRACT

The application provides a cooking appliance and a control method and device thereof, electronic device and a computer-readable storage medium, the cooking appliance includes a cooking cavity, a switch, a cavity partition plate and at least two heating parts, the cavity partition plate is detachably connected to the cooking cavity, in the case that the cavity partition plate is connected to the cooking cavity, the cavity partition plate can trigger the switch; the cavity partition plate divides the cooking cavity into at least two cavities, the at least two heating parts supply heat to the at least two cavities respectively, and the control method includes: receiving a first input of the cooking appliance; in response to the first input, acquiring trigger information of the switch; in the case that the switch is triggered, determining that the temperature control mode of the cooking appliance is a first mode.

### CROSS-REFERENCE TO RELATED APPLICATIONS

This application claims priority to Chinese Patent Application No. 202410160766.X filed with China National Intellectual Property Administration on Feb. 4, 2024, the entire contents of which are herein incorporated by reference.

### FIELD

The present application relates to the field of household appliances, and particularly relates to a cooking appliance, a control method and a device thereof, an electronic device and a computer-readable storage medium.

### BACKGROUND

At present, most cooking appliances have a single cavity. In order to improve cooking efficiency, many manufacturers have further developed cavity partition solutions, such as a solution of left and right partition cavities, and a solution of upper and lower partition cavities, and thus simultaneous cooking in multiple cavities is achieved through multiple heating parts. However, for a cooking appliance in related art, if a cavity partition plate is not installed in place, or the cavity partition plate is not provided, or the sensitivity of a detection component for detecting whether the cavity partition plate is installed in the cooking appliance decreases, it will render the cooking appliance unable to enter an independent control mode of multiple heating parts, thus affecting the cooking of food ingredients.

### SUMMARY

The present application aims to solve at least one of the problems in the prior art or related art.

Therefore, the embodiments of the present application provides a control method for a cooking appliance.

The embodiments of the present application further provides a control device of a cooking appliance.

The embodiments of the present application further provides a cooking appliance.

The embodiments of the present application further provides an electronic device.

The embodiments of the present application further provides a computer-readable storage medium.

In view of this, the embodiments of the present application provides a control method for a cooking appliance, and the cooking appliance includes a cooking cavity, a switch, a cavity partition plate and at least two heating parts. The cavity partition plate is detachably connected to the cooking cavity. In the case that the cavity partition plate is connected to the cooking cavity, the cavity partition plate can trigger the switch. The cavity partition plate divides the cooking cavity into at least two cavities, and at least two heating parts supply heat to at least two cavities respectively. The control method includes: receiving a first input for the cooking appliance; in response to the first input, acquiring trigger information of the switch; in the case that the switch is triggered, determining that the temperature control mode of the cooking appliance is a first mode; in the case that the switch is not triggered, receiving a second input for the temperature control mode; in the case that the second input is the first mode, determining that the temperature control mode is the first mode; and in the first mode, at least two heating parts are respectively controlled to operate.

The control method for a cooking appliance provided by the present application includes: receiving a first input for the cooking appliance; in response to the first input, acquiring the trigger information of the switch: in the case that the switch is triggered, it means that the cavity partition plate is inserted into the cooking cavity and the switch is triggered, and the cooking cavity is divided into at least two cavities, and then it is determined that the temperature control mode of the cooking appliance is the first mode. In the first mode, the at least two heating parts are respectively controlled, i.e., in the first mode, an independent control for the heating parts corresponding to the at least two cavities is achieved, and the at least two cavities achieve cooking in different manners respectively. In the case that the switch is not triggered, it means that the cavity partition plate is not placed in place and thus the switch is not triggered, or the cavity partition plate is not placed in the cooking cavity, or the sensitivity of the switch for detecting whether the cavity partition plate is installed in the cooking cavity decreases, and in this situation, the second input for the temperature control mode is received. If the second input is the first mode, in the case that the cavity partition plate is not placed and in the case that the cavity partition plate is not placed in place, an independent control for the at least two heating parts can further be achieved. Furthermore, in the case that the cavity partition plate is not placed, different baking of the food ingredients on both sides can be achieved, and in the case that the cavity partition plate is not placed in place, the independent control of the food ingredients in at least two cavities can be achieved, and thus cooking effect is improved. The control method for a cooking appliance provided in the present application can achieve the independent control of at least two heating parts regardless of whether the cavity partition plate is installed in the cooking cavity.

It should be noted that in the case that the switch is not triggered, for example, the cavity partition plate is not placed in the cooking cavity, and a baking pan and/or grill are put into the cooking cavity, the switch cannot be triggered when the food ingredients on the baking pan and/or grill are cooked. In the case of entering the first mode, the upper and lower sides of the food ingredients on the baking pan can be baked to different degrees, and this improves the cooking effect.

It is understandable that the number of the cavity partition plates is one or more.

In a specific application, the switch includes a micro switch. In the case that the cavity partition plate is placed inside the cooking cavity, the cavity partition plate triggers the micro switch.

In a specific application, the first mode is an independent control mode, and the second mode is a non-independent control mode.

The control method for a cooking appliance provided in the present application can further include the following additional features.

In some embodiments, the at least two cavities include a first cavity and a second cavity. In the first mode, the steps of respectively controlling at least two heating parts to operate include: respectively controlling at least two heating parts to operate, and the temperature value of the first cavity is greater than or equal to the difference between a first target temperature value and a first threshold, and is less than or equal to the sum of the first target temperature value and the first threshold; and the temperature value of the second cavity is greater than or equal to the difference between a second target temperature value and a second threshold, and is less than or equal to the sum of the second target temperature value and the second threshold.

In some embodiments, the at least two cavities include the first cavity and the second cavity. In the first mode, respectively controlling at least two heating parts to operate includes: respectively controlling at least two heating parts to operate, and at least one heating part supplies heat to the first cavity, and thus the temperature value of the first cavity reaches the first target temperature value, and remains within a range which is greater than or equal to the difference between the first target temperature value and the first threshold, and is less than or equal to the sum of the first target temperature value and the first threshold; controlling at least one heating part to supply heat to the second cavity, and the temperature value of the second cavity reaches the second target temperature value and remains within a range which is greater than or equal to the difference between the second target temperature value and the second threshold, and is less than or equal to the sum of the second target temperature value and the second threshold. In the case that the cavity partition plate is inserted into the cooking cavity, different cooking temperatures of at least two cavities are achieved, and thus the cooking for different food ingredients is achieved. In the case that the cavity partition plate is not inserted into the cooking cavity, different degrees of baking on both sides of the food ingredients can be achieved, and this further adapts to the cooking of different food ingredients.

In some embodiments, in the first mode, the steps of respectively controlling at least two heating parts to operate include: acquiring the temperature value of the first cavity and the temperature value of the second cavity; in the case that the temperature value of the first cavity is greater than or equal to the first target temperature value and the temperature value of the second cavity is greater than or equal to the second target temperature value, controlling the heating part corresponding to the first cavity to operate at a first on-off ratio, and the temperature value of the first cavity is greater than or equal to the difference between the first target temperature value and the first threshold, and is less than or equal to the sum of the first target temperature value and the first threshold; controlling the heating part corresponding to the second cavity to operate at a second on-off ratio, and the temperature value of the second cavity is greater than or equal to the difference between the second target temperature value and the second threshold, and is less than or equal to the sum of the second target temperature value and the second threshold.

In some embodiments, when at least one heating part supplies heat to the first cavity, the temperature value of the first cavity continuously increases until it reaches the first target temperature value. When the temperature value of the first cavity reaches the first target temperature value, the heating part corresponding to the first cavity is controlled to operate at the first on-off ratio, and the temperature value inside the first cavity is maintained within a range which is greater than or equal to the difference between the first target temperature value and the first threshold, and is less than or equal to the sum of the first target temperature value and the first threshold, and the temperature value inside the first cavity tends to be stable, and thus stable baking for the food ingredients is achieved. Correspondingly, when at least one heating part supplies heat to the second cavity, the temperature value of the second cavity continuously increases until it reaches the second target temperature value. When the temperature value of the second cavity reaches the second target temperature value, the heating part corresponding to the second cavity is controlled to operate at the second on-off ratio, and the temperature value inside the second cavity is maintained within a range which is greater than or equal to the difference between the second target temperature value and the second threshold, and is less than or equal to the sum of the second target temperature value and the second threshold, and the temperature value inside the second cavity tends to be stable, and then stable baking for the food ingredients is achieved.

It is understandable that in the case that the cavity partition plate is provided inside the cooking cavity, the cavity partition plate divides the cooking cavity into the first cavity and the second cavity. The first cavity and the second cavity can achieve independence by the separation of the cavity partition plate, and furthermore, the temperature influence between them is relatively small, and classified baking for different food ingredients can be better achieved.

In some embodiments, the cooking appliance further includes a baking pan. When the baking pan is provided in the cooking cavity, the baking pan divides the cooking cavity into a first cavity and a second cavity. In the first mode, the steps of respectively controlling at least two heating parts to operate include: in the case that the temperature value of the first cavity is greater than or equal to the first target temperature value and the temperature value of the second cavity is less than the difference between the second target temperature value and the second threshold, controlling the heating part corresponding to the first cavity to operate at a third on-off ratio, and controlling the heating part corresponding to the second cavity to operate at a fourth on-off ratio; and the third on-off ratio is less than the first on-off ratio, and the fourth on-off ratio is greater than or equal to the second on-off ratio.

In some embodiments, the cooking appliance further includes the baking pan, which is provided inside the cooking cavity and can divide the cooking cavity into the first cavity and the second cavity. At least two heating parts supply heat to the first cavity and the second cavity respectively, and thus this enables baking the top surface and the bottom surface of the food ingredients on the baking pan to different degrees, and thus different cooking effects are achieved. And in the first mode, that is, in an independent control mode of the first cavity and the second cavity, the operating temperatures of at least two heating parts are different, and thus the temperature rise speeds of the first cavity and the second cavity are different, in the case that the temperature value of one of the first cavity and the second cavity reaches the target temperature value while the temperature of the other cavity is still relatively low, for example, in the case that the temperature value of the first cavity is greater than or equal to the first target temperature value and the temperature value of the second cavity is less than the difference between the second target temperature value and the second threshold, the on-off ratio of the heating part corresponding to the second cavity is increased to make the heating part corresponding to the second cavity operate at the fourth on-off ratio, and this further makes the temperature of the second cavity rise rapidly. At the same time, since the heat will be transferred to the first cavity, in order to avoid an excessively high temperature in the first cavity, the on-off ratio of the heating part corresponding to the first cavity is reduced to make the first cavity operate at the third on-off ratio, and this further makes the temperature of the second cavity rise quickly without causing the occurrence of the circumstance of an excessively high temperature value of the first cavity.

The first cavity is located on the top of the second cavity.

In some embodiments, the third on-off ratio is less than or equal to ½ of the first on-off ratio.

In some embodiments, the third on-off ratio is less than or equal to ½ of the first on-off ratio, to avoid the occurrence of the circumstance of excessively rapid temperature rise of the temperature value in the first cavity.

In some embodiments, the control method for a cooking appliance further includes: receiving input for the first target temperature value and the second target temperature value, or identifying food ingredient information inside the cooking cavity, and determining the first target temperature value and the second target temperature value based on the food ingredient information.

In some embodiments, for the first target temperature value and the second target temperature value, they can be actively input by a user or determined based on different food ingredient information.

In some embodiments, the temperature control mode further includes a second mode; in the case that the second input is the second mode, controlling at least two heating parts operate at a third target temperature value.

In some embodiments, the temperature control mode further includes the second mode. In the case that the switch is not triggered, the cavity partition plate is not installed in the cooking cavity, or the cavity partition plate is not installed in place, then the second input from the user is received to conduct second confirmation of the temperature control mode. In the case that the second input is the second mode, it means that the cavity partition plate is not placed, and food ingredients are cooked through a large cooking cavity, and then, at least two heating parts are controlled to operate at the third target temperature value, that is, the heating temperatures and heating parameters of at least two heating parts are made to be the same, and thus synchronous baking of the food ingredients by at least two heating parts is realized, and the cooking efficiency is improved.

In some embodiments, in the case that the switch is not triggered, the cavity partition plate is separated from the cooking cavity, or the cavity partition plate is not installed in place.

In some embodiments, in the case that the switch is not triggered, it is possible that the cavity partition plate is separated from the cooking cavity, or the cavity partition plate is not installed in place, and in either case of the two cases, it is possible to enter the first mode or the second mode according to the second input. In the first mode, independent control of at least two heating parts is realized, and then different degrees of cooking are achieved. In the second mode, synchronous control of at least two heating parts is realized to improve cooking efficiency.

In some embodiments, the control method for a cooking appliance further includes: controlling at least two heating parts to preheat at a corresponding fourth target temperature value.

In some embodiments, the control method for a cooking appliance further includes: controlling at least two heating parts to preheat at the corresponding fourth target temperature value, thus improving the cooking effect of the food ingredients.

In some embodiments, in the first mode, the steps of respectively controlling at least two heating parts to operate further include: controlling at least two heating parts to respectively operate for a first target duration and a second target duration.

In some embodiments, in the first mode, the steps of respectively controlling at least two heating parts to operate further include: controlling at least two heating parts to respectively operate for the first target duration and the second target duration, and the at least two cavities achieve different cooking.

In one embodiment, the first target duration and the second target duration can be input by a user or recognized based on the type and weight of the food ingredients.

According to the embodiments of the present application, a control device of a cooking appliance is further provided, and the cooking appliance includes a cooking cavity, a switch, a cavity partition plate and at least two heating parts. The cavity partition plate is detachably connected to the cooking cavity. In the case that the cavity partition plate is connected to the cooking cavity, the cavity partition plate can trigger the switch. The cavity partition plate divides the cooking cavity into at least two cavities, and at least two heating parts supply heat to at least two cavities respectively. The control device includes: a receiving unit, configured to receive a first input for the cooking appliance; a responding unit, configured to respond to the first input; an acquiring unit, configured to acquire the trigger information of the switch; a determining unit, configured to determine that the temperature control mode of the cooking appliance is a first mode in the case that the switch is triggered; and in the case that the switch is not triggered, the receiving unit is further configured to receive a second input for the temperature control mode; in the case that the second input is the first mode, the determining unit is further configured to determine that the temperature control mode is the first mode; in the first mode, the control unit is configured to control at least two heating parts respectively to operate.

The control device of a cooking appliance provided by the embodiments of the present application includes the receiving unit, the responding unit, the acquiring unit and the determining unit. The receiving unit is configured to receive a first input for the cooking appliance; the responding unit responds to the first input; the acquiring unit acquires the trigger information of the switch: in the case that the switch is triggered, it means that the cavity partition plate is inserted into the cooking cavity and the switch is triggered, and the cooking cavity is divided into at least two cavities, and then the determining unit determines that the temperature control mode of the cooking appliance is the first mode. In the first mode, the control unit controls at least two heating parts respectively, i.e., in the first mode, the independent control for the heating parts corresponding to the at least two cavities is achieved, and the at least two cavities achieve cooking in different manners respectively. In the case that the switch is not triggered, it means that the cavity partition plate is not placed in place and thus the switch is not triggered, or the cavity partition plate is not placed in the cooking cavity, and the interior of the cooking appliance is a large cooking cavity, and in this situation, the receiving unit receives the second input for the temperature control mode. If the second input is the first mode, in the case that the cavity partition plate is not placed and in the case that the cavity partition plate is not placed in place, the independent control for the at least two heating parts can further be achieved. Furthermore, in the case that the cavity partition plate is not placed, different baking of the food ingredients on both sides can be achieved, and in the case that the cavity partition plate is not placed in place, the independent control of the food ingredients in at least two cavities can be achieved, and thus the cooking effect is improved. The control device of a cooking appliance provided in the present application can achieve the independent control of at least two heating parts regardless of whether the cavity partition plate is installed in the cooking cavity.

According to the embodiments of the present application, a cooking appliance is further provided, and the cooking appliance includes a cooking cavity, a switch, a cavity partition plate and at least two heating parts. The cavity partition plate is detachably connected to the cooking cavity. In the case that the cavity partition plate is connected to the cooking cavity, the cavity partition plate can trigger the switch. The cavity partition plate divides the cooking cavity into at least two cavities, and at least two heating parts supply heat to at least two cavities respectively. In addition, the cooking appliance further includes the control device provided in any of the above items.

The cooking appliance provided by the present application includes a cooking cavity, a switch, a cavity partition plate and at least two heating parts. The cavity partition plate is detachably connected to the cooking cavity. In the case that the cavity partition plate is installed inside the cooking cavity, the cavity partition plate divides the cooking cavity into at least two cavities, and then the cooking of different food ingredients is achieved respectively through the at least two cavities, and thus the cooking efficiency is improved. In the case that the cavity partition plate is separated from the cooking cavity, the volume of the cooking cavity is relatively large, which enables the cooking of food ingredients with a relatively large volume, at the same time, the at least two heating parts can be configured to cook one type of food ingredient simultaneously, and this improves cooking efficiency. In addition, in the case that the cavity partition plate is installed inside the cooking cavity, the cavity partition plate can trigger the switch, and then the control device controls at least two cavities to enter the first mode in the case that the switch is triggered, and then the independent control of at least two cavities is achieved. In the case that the switch is not triggered, it means that the cavity partition plate is not placed in place and thus the switch is not triggered, or the cavity partition plate is not placed in the cooking cavity, and the inside of the cooking appliance is a large cooking cavity, in this case, the second input for the temperature control mode is received, if the second input is the first mode, in the case that the cavity partition plate is not placed and the cavity partition plate is not placed in place, the independent control of at least two heating parts can further be achieved. Furthermore, in the case that the cavity partition plate is not placed, different baking on both sides of the food ingredients is achieved, and in the case that the cavity partition plate is not placed in place, the independent control of the food ingredients in at least two cavities is achieved, and thus the cooking effect is improved. The cooking appliance provided in the present application can achieve the independent control of at least two heating parts regardless of whether the cavity partition plate is installed inside the cooking cavity.

The at least two cavities include a first cavity and a second cavity, that is, the cavity partition plate at least divides the cooking cavity into the first cavity and the second cavity.

In some embodiments, in the case that the switch is not triggered, the cavity partition plate is separated from the cooking cavity or the cavity partition plate is not installed in place.

In some embodiments, in the case that the switch is not triggered, it is possible that the cavity partition plate is separated from the cooking cavity, or the cavity partition plate is not installed in place. In either case of the two cases, it is possible to achieve entering the first mode or the second mode according to the second input. In the first mode, the independent control of at least two heating parts can be realized, and then different degrees of cooking are achieved. In the second mode, synchronous control of at least two heating parts is realized to improve cooking efficiency.

In some embodiments, the at least two cavities include a first cavity and a second cavity, which are distributed along a vertical direction; and/or the cooking appliance further includes a baking pan, which is detachably arranged inside the cooking cavity and divides the cooking cavity into the first cavity and the second cavity.

In some embodiments, the at least two cavities include the first cavity and the second cavity, which are distributed along the vertical direction, and this reduces the occupation of the horizontal space of the kitchen by the cooking appliance and facilitates the storage of the cooking appliance. The cooking appliance further includes the baking pan, which divides the cooking cavity into the first cavity and the second cavity. The baking pan can carry the food ingredients and further achieves the cooking of the food ingredients through the first cavity and the second cavity, respectively.

In some embodiments, the heating part includes a hot air assembly, and at least two hot air assemblies are configured to deliver hot air into the cooking cavity.

In some embodiments, the heating part includes the hot air assembly, and the hot air assembly can deliver hot air into the cooking cavity, and this further achieves air frying of the food ingredients.

In some embodiments, the heating part includes a heating tube for radiating heat into the cooking cavity.

In some embodiments, the heating part further includes a microwave generating part configured to feed microwaves into the cooking cavity.

In some embodiments, the heating part further includes the microwave generating part configured to feed microwaves into the cooking cavity, and this further achieves microwave cooking of the food ingredients inside the cooking cavity.

According to the embodiments of the present application, an electronic device is further provided, including: a processor and a memory, and the memory stores programs or instructions which can be executed on the processor, when the programs or instructions are executed by the processor, the steps of the control method for a cooking appliance provided in any of the embodiments are achieved. Therefore, the electronic device has all the beneficial effects of the control method for a cooking appliance, which will not be repeated here.

According to the embodiments of the present application, a computer-readable storage medium is further provided, in which programs or instructions are stored, when the programs or instructions are executed by a processor, the control method for a cooking appliance provided in any of the embodiments are implemented. Therefore, the computer-readable storage medium has all the beneficial effects of the control method for a cooking appliance, which will not be repeated here.

The additional embodiments of the present application will be partially obvious in the following description, or learned through practice of the present application.

### BRIEF DESCRIPTION OF THE DRAWINGS

The above and/or additional embodiments of the present application will become apparent and easily understood from the description of the embodiments in combination with the following accompanying drawings:

FIG. 1 is a first flow chart of a control method for a cooking appliance in an embodiment of the present application;

FIG. 2 is a second flow chart of a control method for a cooking appliance in an embodiment of the present application;

FIG. 3 is a third flow chart of a control method for a cooking appliance in an embodiment of the present application;

FIG. 4 is a first schematic view of the structure of a cooking appliance in an embodiment of the present application;

FIG. 5 is a second schematic view of the structure of a cooking appliance

in an embodiment of the present application;

FIG. 6 is a schematic block diagram of a heating part in an embodiment of the present application;

FIG. 7 is a schematic block diagram of a control device of a cooking appliance in an embodiment of the present application; and

FIG. 8 is a schematic block diagram of an electronic device in an embodiment of the present application.

The corresponding relationships between the reference signs and the component names in FIG. 4 to FIG. 6 are as follows:

1 cooking cavity, 10 cavity body, 102 first cavity, 104 second cavity, 2 switch, 3 cavity partition plate, 30 baking pan, 4 heating part, 40 hot air assembly, 42 microwave generating part, 5 control device.

### DETAILED DESCRIPTION OF THE DISCLOSURE

To more clearly understand the above embodiments of the present application, the present application will be further detailed hereinafter in combination with the accompanying drawings and embodiments. It should be indicated that the embodiments and the features in the embodiments can be combined with each other in the case of no conflict.

Many details are illustrated in the following description for the convenience of a thorough understanding of the present application, but the present application can further be implemented using other embodiments other than these described herein. Therefore, the protection scope of the present application is not limited to the specific embodiments disclosed in the following text.

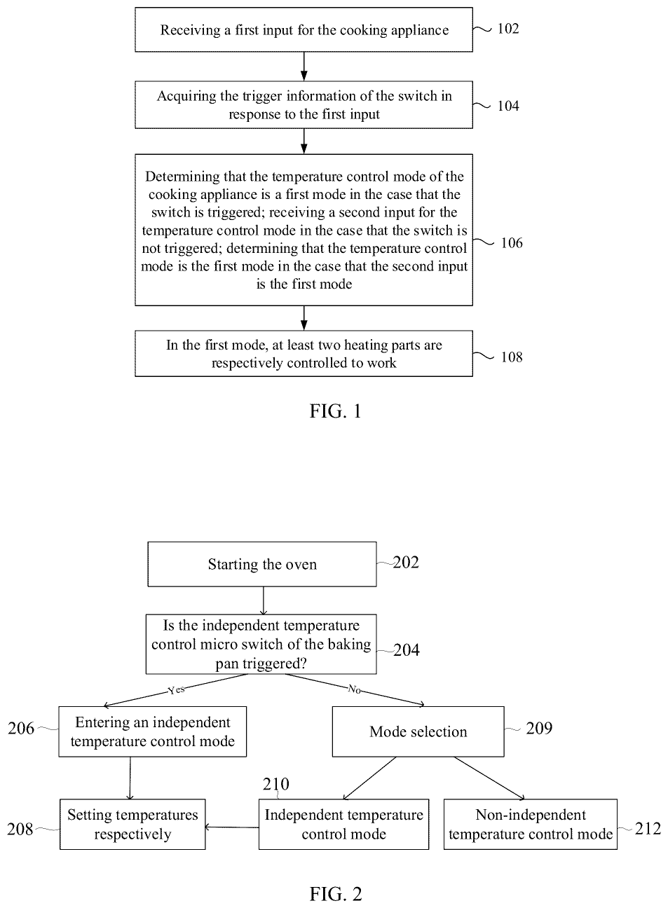

A control method for a cooking appliance, a control device of a cooking appliance, a cooking appliance, an electronic device and a computer-readable storage medium provided in some embodiments of the present application are described in the following text by referring to FIG. 1 to FIG. 8.

According to an embodiment of the present application, the present application provides a control method for a cooking appliance, and the cooking appliance includes a cooking cavity, a switch, a cavity partition plate and at least two heating parts. The cavity partition plate is detachably connected to the cooking cavity. In the case that the cavity partition plate is connected to the cooking cavity, the cavity partition plate can trigger the switch.

The cavity partition plate divides the cooking cavity into at least two cavities, and the at least two heating parts supply heat to the at least two cavities respectively. As shown in FIG. 1, it illustrates a flow chart of a control method for a cooking appliance.

Step 102: receiving a first input for the cooking appliance;

Step 104: in response to the first input, acquiring trigger information of the switch;

Step 106: in the case that the switch is triggered, determining that the temperature control mode of the cooking appliance is a first mode; in the case that the switch is not triggered, receiving a second input for the temperature control mode; in the case that the second input is the first mode, determining that the temperature control mode is the first mode;

Step 108: in the first mode, the at least two heating parts are respectively controlled to operate.

The control method for a cooking appliance provided by the present application includes: receiving a first input for the cooking appliance; in response to the first input, acquiring the trigger information of the switch: in the case that the switch is triggered, it means that the cavity partition plate is inserted into the cooking cavity and the switch is triggered, and the cooking cavity is divided into at least two cavities, and then it is determined that the temperature control mode of the cooking appliance is the first mode. In the first mode, the at least two heating parts are respectively controlled, i.e., in the first mode, an independent control for the heating parts corresponding to the at least two cavities is achieved, and the at least two cavities achieve cooking in different manners respectively. In the case that the switch is not triggered, it means that the cavity partition plate is not placed in place and thus the switch is not triggered, or the cavity partition plate is not placed in the cooking cavity, and in this situation, the second input for the temperature control mode is received. If the second input is the first mode, in the case that the cavity partition plate is not placed and in the case that the cavity partition plate is not placed in place, an independent control for the at least two heating parts can further be achieved. Furthermore, in the case that the cavity partition plate is not placed, different baking of the food ingredients on both sides can be achieved, and in the case that the cavity partition plate is not placed in place, the independent control of the food ingredients in at least two cavities can be achieved, and thus cooking efficiency is improved. The control method for a cooking appliance provided in the present application can achieve the independent control of at least two heating parts regardless of whether the cavity partition plate is installed in the cooking cavity.

It should be noted that in the case that the switch is not triggered, for example, the cavity partition plate is not placed in the cooking cavity, and a baking pan and/or grill are put into the cooking cavity, the switch cannot be triggered when the food ingredients on the baking pan and/or grill are cooked. In the case of entering the first mode, the upper and lower sides of the food ingredients on the baking pan can be baked to different degrees, and this improves the cooking effect.

It is understandable that the number of the cavity partition plates is one or more.

In a specific application, the switch includes a micro switch. In the case that the cavity partition plate is placed inside the cooking cavity, the cavity partition plate triggers the micro switch.

In a specific application, the first mode is an independent control mode, and the second mode is a non-independent control mode.

In some embodiments, the at least two cavities include a first cavity and a second cavity. In the first mode, the steps of respectively controlling at least two heating parts to operate include: respectively controlling the at least two heating parts to operate, and the temperature value of the first cavity is greater than or equal to the difference between a first target temperature value and a first threshold, and is less than or equal to the sum of the first target temperature value and the first threshold; and the temperature value of the second cavity is greater than or equal to the difference between a second target temperature value and a second threshold, and is less than or equal to the sum of the second target temperature value and the second threshold.

In the embodiment, the at least two cavities include the first cavity and the second cavity. In the first mode, respectively controlling at least two heating parts to operate includes: respectively controlling the at least two heating parts to operate, and at least one heating part supplies heat to the first cavity, and thus the temperature value of the first cavity reaches the first target temperature value, and remains within a range which is greater than or equal to the difference between the first target temperature value and the first threshold, and is less than or equal to the sum of the first target temperature value and the first threshold; controlling at least one heating part to supply heat to the second cavity, and the temperature value of the second cavity reaches the second target temperature value and remains within a range which is greater than or equal to the difference between the second target temperature value and the second threshold, and is less than or equal to the sum of the second target temperature value and the second threshold. In the case that the cavity partition plate is inserted into the cooking cavity, different cooking temperatures of at least two cavities are achieved, and thus the cooking for different food ingredients is achieved. In the case that the cavity partition plate is not inserted into the cooking cavity, different degrees of baking on both sides of the food ingredients can be achieved, and this further adapts to the cooking of different food ingredients.

The first target temperature value and the second target temperature value are different, and the heating temperatures and heating duration of at least two heating parts are the same or different. Therefore, in the first mode, at least two heating parts can heat at different heating temperatures and different heating duration, or operate at different heating temperatures and at the same heating duration, or operate at the same heating temperature and at different heating duration, or operate at the same heating temperature and at the same heating duration.

In one embodiment, the specific numeric values of the first target temperature value and the second target temperature value are set based on actual cooked dishes.

In a specific application, a user can achieve independent temperature control of divided cavities through the cavity partition plate. When the cavity partition plate is not used, the user can set upper and lower cooking temperatures separately to make a dish. For example, when egg tarts are cooked, the upper baking temperature requirement is 200° C., and the lower baking temperature requirement is 180° C., which can be set separately.

The first target temperature value input by a user is received, then a first temperature range (e.g., the first target temperature value±the first threshold) is determined, and the corresponding heating part is controlled to operate according to the first temperature range; the second target temperature value input by a user is received, then a second temperature range (e.g. the second target temperature value±the second threshold) is determined, and the corresponding heating part is controlled to operate according to the second temperature range.

It can be understood that the first temperature range is obtained by fluctuating the first target temperature value up and down, and the fluctuating temperature range (such as the first threshold) can be from 0° C. to 3° C.; the second temperature range is obtained by fluctuating the second target temperature value up and down, and the fluctuating temperature range (e.g. second threshold) can be from 0° C. to 3° C.

According to some embodiments of the present application, in the first mode, the steps of respectively controlling at least two heating parts to operate include: acquiring the temperature value of the first cavity and the temperature value of the second cavity; in the case that the temperature value of the first cavity is greater than or equal to the first target temperature value and the temperature value of the second cavity is greater than or equal to the second target temperature value, controlling the heating part corresponding to the first cavity to operate at a first on-off ratio, and the temperature value of the first cavity is greater than or equal to the difference between the first target temperature value and the first threshold, and is less than or equal to the sum of the first target temperature value and the first threshold; controlling the heating part corresponding to the second cavity to operate at a second on-off ratio, and the temperature value of the second cavity is greater than or equal to the difference between the second target temperature value and the second threshold, and is less than or equal to the sum of the second target temperature value and the second threshold.

In the embodiment, when at least one heating part supplies heat to the first cavity, the temperature value of the first cavity continuously increases until it reaches the first target temperature value. When the temperature value of the first cavity reaches the first target temperature value, the heating part corresponding to the first cavity is controlled to operate at the first on-off ratio, and the temperature value inside the first cavity is maintained within a range which is greater than or equal to the difference between the first target temperature value and the first threshold, and is less than or equal to the sum of the first target temperature value and the first threshold, and the temperature value inside the first cavity tends to be stable, and thus stable baking for the food ingredients is achieved. Correspondingly, when at least one heating part supplies heat to the second cavity, the temperature value of the second cavity continuously increases until it reaches the second target temperature value. When the temperature value of the second cavity reaches the second target temperature value, the heating part corresponding to the second cavity is controlled to operate at the second on-off ratio, and the temperature value inside the second cavity is maintained within a range which is greater than or equal to the difference between the second target temperature value and the second threshold, and is less than or equal to the sum of the second target temperature value and the second threshold, and the temperature value inside the second cavity tends to be stable, and then stable baking for the food ingredients is achieved.

It is understandable that in the case that the cavity partition plate is provided inside the cooking cavity, the cavity partition plate divides the cooking cavity into the first cavity and the second cavity. The first cavity and the second cavity can achieve independence by the separation of the cavity partition plate, and furthermore, the temperature influence between them is relatively small, and classified baking for different food ingredients can be better achieved.

According to some embodiments of the present application, the cooking appliance further includes a baking pan. When the baking pan is provided in the cooking cavity, the baking pan divides the cooking cavity into a first cavity and a second cavity. In the first mode, the steps of respectively controlling at least two heating parts to operate include: in the case that the temperature value of the first cavity is greater than or equal to the first target temperature value and the temperature value of the second cavity is less than the difference between the second target temperature value and the second threshold, controlling the heating part corresponding to the first cavity to operate at a third on-off ratio, and controlling the heating part corresponding to the second cavity to operate at a fourth on-off ratio; and the third on-off ratio is less than the first on-off ratio, and the fourth on-off ratio is greater than or equal to the second on-off ratio.

In the embodiment, the cooking appliance further includes the baking pan, which is provided inside the cooking cavity and can divide the cooking cavity into the first cavity and the second cavity. At least two heating parts supply heat to the first cavity and the second cavity respectively, and thus this enables baking the top surface and the bottom surface of the food ingredients on the baking pan to different degrees, and thus different cooking effects are achieved. And in the first mode, that is, in an independent control mode of the first cavity and the second cavity, the operating temperatures of at least two heating parts are different, and thus the temperature rise speeds of the first cavity and the second cavity are different, in the case that the temperature value of one of the first cavity and the second cavity reaches the target temperature value while the temperature of the other cavity is still relatively low, for example, in the case that the temperature value of the first cavity is greater than or equal to the first target temperature value and the temperature value of the second cavity is less than the difference between the second target temperature value and the second threshold, the on-off ratio of the heating part corresponding to the second cavity is increased to make the heating part corresponding to the second cavity operate at the fourth on-off ratio, and this further makes the temperature of the second cavity rise rapidly. At the same time, since the heat will be transferred to the first cavity, in order to avoid an excessively high temperature in the first cavity, the on-off ratio of the heating part corresponding to the first cavity is reduced to make the first cavity operate at the third on-off ratio, and this further makes the temperature of the second cavity rise quickly without causing the occurrence of the circumstance of an excessively high temperature value of the first cavity.

The first cavity is located on the top of the second cavity.

According to some embodiments of the present application, the third on-off ratio is less than or equal to ½ of the first on-off ratio.

In the embodiment, the third on-off ratio is less than or equal to ½ of the first on-off ratio, to avoid the occurrence of the circumstance of excessively rapid temperature rise of the temperature value in the first cavity.

According to some embodiments of the present application, the control method for a cooking appliance further includes: receiving input for the first target temperature value and the second target temperature value, or identifying food ingredient information inside the cooking cavity, and determining the first target temperature value and the second target temperature value based on the food ingredient information.

In the embodiment, for the first target temperature value and the second target temperature value, they can be actively input by a user or determined based on different food ingredient information.

In one embodiment, the food ingredient information includes the type and weight of the food ingredient. The cooking appliance can store heating temperatures and heating duration corresponding to different food ingredients and different weights in advance.

An identification unit is provided inside the cooking appliance, and configured to recognize food ingredient information.

According to some embodiments of the present application, the temperature control mode further includes a second mode; in the case that the second input is the second mode, controlling at least two heating parts to operate at a third target temperature value.

In the embodiment, the temperature control mode further includes the second mode. In the case that the switch is not triggered, the cavity partition plate is not installed in the cooking cavity, or the cavity partition plate is not installed in place, then the second input from the user is received to conduct second confirmation of the temperature control mode. In the case that the second input is the second mode, it means that the cavity partition plate is not placed, and food ingredients are cooked through a large cooking cavity, and then, at least two heating parts are controlled to operate at the third target temperature value, that is, the heating temperatures and heating parameters of at least two heating parts are made to be the same, and thus synchronous baking of the food ingredients by at least two heating parts is realized, and the cooking efficiency is improved.

It is understandable that the third target temperature value is set based on actual cooked dishes.

In one embodiment, the third target temperature value can be obtained through user's input or automatically determined by identifying dish information. In one embodiment, the third target temperature value input by the user is received, then the third temperature range is determined, and at least two heating parts are controlled to operate according to the third temperature range.

The third temperature range is obtained by fluctuating the third target temperature value up and down, and the fluctuating temperature range can be from 0° C. to 3° C.

According to some embodiments of the present application, in the case that the switch is not triggered, the cavity partition plate is separated from the cooking cavity, or the cavity partition plate is not installed in place.

In the embodiment, in the case that the switch is not triggered, it is possible that the cavity partition plate is separated from the cooking cavity, or the cavity partition plate is not installed in place, and in either case of the two cases, it is possible to enter the first mode or the second mode according to the second input. In the first mode, independent control of at least two heating parts is realized, and then different degrees of cooking are achieved. In the second mode, synchronous control of at least two heating parts is realized to improve cooking efficiency.

According to some embodiments of the present application, the control method for a cooking appliance further includes: controlling at least two heating parts to preheat at a corresponding fourth target temperature value.

In the embodiment, the control method for a cooking appliance further includes: controlling at least two heating parts to preheat at the corresponding fourth target temperature value, thus improving the cooking effect of the food ingredients.

It can be understood that the fourth target temperature value can be a heating temperature manually input by a user or a heating temperature automatically confirmed by the cooking appliance.

According to some embodiments of the present application, in the first mode, the steps of respectively controlling at least two heating parts to operate further includes: controlling at least two heating parts to respectively operate for a first target duration and a second target duration.

In the embodiment, in the first mode, the steps of respectively controlling at least two heating parts to operate further include: controlling at least two heating parts to respectively operate for the first target duration and the second target duration, and the at least two cavities achieve different cooking.

In one embodiment, the first target duration and the second target duration can be input by a user or recognized based on the type and weight of the food ingredient.

In a specific application, the present application can achieve different cooking effects by setting the temperature rise curve that a user wants to achieve, which is more suitable for kitchen experts such as cooking masters. And the cooking appliance includes an oven.

As shown in FIG. 2, a flowchart of a control method for an oven is illustrated:

Step 202: starting the oven;

Step 204: is the independent temperature control micro switch of the

baking pan triggered? if yes, proceeding to step 206; if not, proceeding to step 209;

Step 206: entering an independent temperature control mode;

Step 208: setting temperatures respectively;

Step 209: mode selection: if the independent temperature control mode is selected, proceeding to step 210; if the non-independent temperature control mode is selected, proceeding to step 212;

Step 210: proceeding to step 208 if it is the independent temperature control mode;

Step 212: the non-independent temperature control mode.

As shown in FIG. 2, regardless of whether there is a cavity partition plate, it can enter the independent temperature control mode. FIG. 4 illustrates the structural position of the oven when the cavity partition plate is inserted.

According to the present application, a user can achieve independent temperature control of divided cavities through the cavity partition plate. When the cavity partition plate is not used, the user can set upper and lower cooking temperatures separately to make a dish, such as egg tarts. The upper baking temperature requirement is 200° C., and the lower baking temperature requirement is 180° C., which can be set separately.

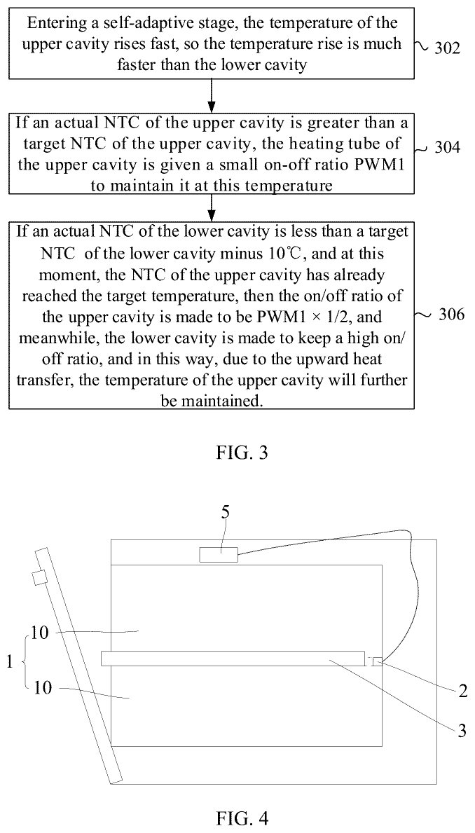

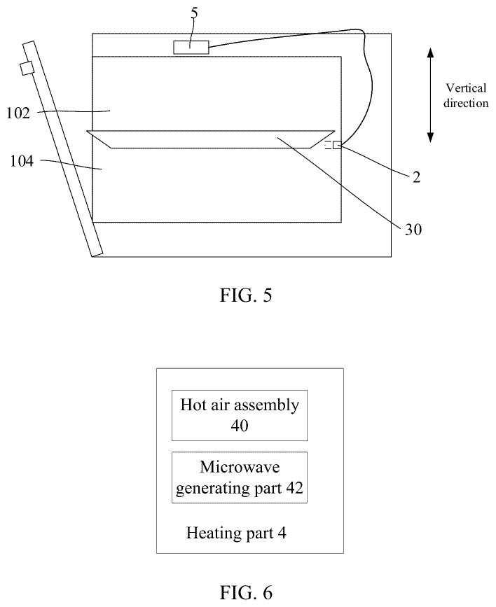

FIG. 2 is the core part of the entire application, and the independent temperature control mode can be entered regardless of whether there is a cavity partition plate. FIG. 4 illustrates the structural position when the cavity partition plate is inserted into the oven. The cavity partition plate will directly press against the micro switch, the micro switch is triggered and the independent temperature control mode of the cavity partition plate is entered. FIG. 5 shows the position of the baking pan when inserted into the cooking cavity. In most cases, the placing position of the baking pan cannot trigger the micro switch, and users need the function of independent temperature control, and can manually enter the independent temperature control mode of the baking pan. FIG. 3 shows the control logic of the independent temperature control mode of the baking pan. There is a slight control logic difference between the independent temperature control mode of the cavity partition plate and the independent temperature control mode of the baking pan. The independent temperature control mode of the cavity partition plate divides the cooking cavity through the cavity partition plate to control the temperatures of the upper and lower cavities separately, and the heat exchange between the upper and lower cavities is conducted through the cavity partition plate. In addition, the independent temperature control mode of the baking pan is different from the application scenario of the cavity partition plate. This application scenario is to complete a menu that requires a temperature difference between the upper and lower cavities, such as baking egg tarts. The upper part of the egg tart requires 200° C., and the lower part requires 220° C., so this temperature control mode is needed. The independent temperature control of the cavity partition plate is divided into a temperature rise stage and a constant temperature stage. At the intersection of the two stages, it will quickly switch to the next stage. However, in the independent temperature control mode of the baking pan, there will be a stage that widens the temperature difference between the two stages, and this stage is called a self-adaptive stage, i.e., the upper and lower cavities will determine how to carry out temperature rise based on the temperature of a current negative temperature coefficient (NTC). The specific control is shown in FIG. 3.

As shown in FIG. 3, the flow chart of the control method is illustrated in the case that the baking pan is placed in the cooking cavity.

Step 302: entering a self-adaptive stage, in which the temperature of the upper cavity rises fast, so the temperature rise is much faster than the lower cavity;

Step 304: if an actual NTC of the upper cavity is greater than a target NTC of the upper cavity, the heating tube of the upper cavity is given a small on-off ratio PWM1 to maintain it at this temperature;

Step 306: if an actual NTC of the lower cavity is less than a target NTC of the lower cavity minus 10° C., and at this moment, the NTC of the upper cavity has already reached the target temperature, then the on/off ratio of the upper cavity is made to be PWM1×1/2, and meanwhile, the lower cavity is made to keep a high on/off ratio, and in this way, due to the upward heat transfer, the temperature of the upper cavity will further be maintained.

And PWM (Pulse Width Modulation) indicates pulse width modulation.

Embodiment 1: a user needs to make 1000 g of roasted sweet potatoes in the upper cavity and 500 g of roasted chicken in the lower cavity. It is necessary to set 230° C. and 60 minutes for the upper cavity and set 200° C. and 80 minutes for the lower cavity. After the cavity partition plate is inserted, the independent temperature control mode is entered, 230° C. is set for the upper cavity and 200° C. is set for the lower cavity respectively, and after preheating for 10 minutes, the prepared food ingredients are put inside separately, and after the time is set, the cooking starts. After 80 minutes, they can be taken out together, and the user can further take out the sweet potato first halfway.

Embodiment 2: when cooking a piece of Chiffon Cake, a top master chef requires the temperature of the baking pan below to be maintained at 180° C., and the temperature radiated from the top should not be too high (such as 150° C.). After the baking pan is inserted, the user manually selects to enter the independent temperature control mode, sets the temperature, and then preheats. After 8 minutes of preheating, the food is added and cooked for 20 minutes to complete the cooking.

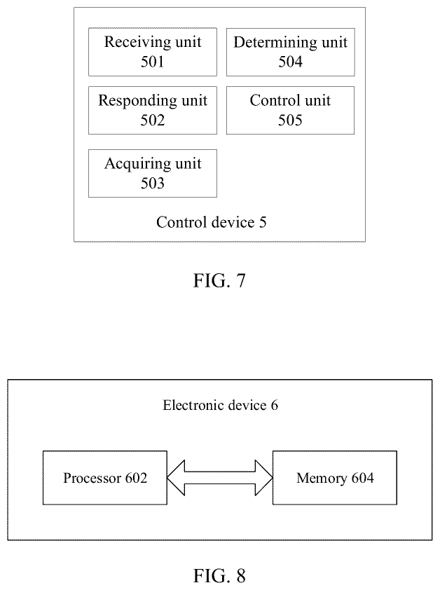

As shown in FIG. 7, according to an embodiment of the present application, a control device 5 of a cooking appliance is further provided, the cooking appliance includes a cooking cavity, a switch, a cavity partition plate and at least two heating parts. The cavity partition plate is detachably connected to the cooking cavity. In the case that the cavity partition plate is connected to the cooking cavity, the cavity partition plate can trigger the switch. The cavity partition plate divides the cooking cavity into at least two cavities, and the at least two heating parts supply heat to the at least two cavities respectively. The control device 5 includes: a receiving unit 501, configured to receive a first input for the cooking appliance; a responding unit 502, configured to respond to the first input; an acquiring unit 503, configured to acquire trigger information of the switch; a determining unit 504, configured to determine that the temperature control mode of the cooking appliance is a first mode in the case that the switch is triggered; and in the case that the switch is not triggered, the receiving unit 501 is further configured to receive a second input for the temperature control mode; in the case that the second input is the first mode, the determining unit 504 is further configured to determine that the temperature control mode is the first mode; in the first mode, the control unit 505 is configured to control at least two heating parts respectively to operate.

The control device 5 of a cooking appliance provided by the present application includes the receiving unit 501, the responding unit 502, the acquiring unit 503 and the determining unit 504. The receiving unit 501 is configured to receive a first input for the cooking appliance; the responding unit 502 responds to the first input; the acquiring unit 503 acquires the trigger information of the switch: in the case that the switch is triggered, it means that the cavity partition plate is inserted into the cooking cavity and the switch is triggered, and the cooking cavity is divided into at least two cavities, and then the determining unit 504 determines that the temperature control mode of the cooking appliance is the first mode. In the first mode, the control unit 505 controls at least two heating parts respectively, i.e., in the first mode, an independent control for the heating parts corresponding to the at least two cavities is achieved, and the at least two cavities achieve cooking in different manners respectively. In the case that the switch is not triggered, it means that the cavity partition plate is not placed in place and thus the switch is not triggered, or the cavity partition plate is not placed in the cooking cavity, and the interior of the cooking appliance is a large cooking cavity, and in this situation, the receiving unit 501 receives the second input for the temperature control mode. If the second input is the first mode, in the case that the cavity partition plate is not placed and in the case that the cavity partition plate is not placed in place, an independent control for the at least two heating parts can further be achieved. Furthermore, in the case that the cavity partition plate is not placed, different baking of the food ingredients on both sides can be achieved, and in the case that the cavity partition plate is not placed in place, the independent control of the food ingredients in at least two cavities can be achieved, and thus cooking efficiency is improved. The control device 5 of a cooking appliance provided in the present application can achieve the independent control of at least two heating parts regardless of whether the cavity partition plate is installed in the cooking cavity.

It should be noted that in the case that the switch is not triggered, for example, the cavity partition plate is not placed in the cooking cavity, and a baking pan and/or grill are put into the cooking cavity, the switch cannot be triggered when the food ingredients on the baking pan and/or grill are cooked. In the case of entering the first mode, the upper and lower sides of the food ingredients on the baking pan can be baked to different degrees, and this improves the cooking effect.

It is understandable that the number of the cavity partition plates is one or more.

In a specific application, the switch includes a micro switch. In the case that the cavity partition plate is placed inside the cooking cavity, the cavity partition plate triggers the micro switch.

In a specific application, the first mode is an independent control mode, and the second mode is a non-independent control mode.

According to some embodiments of the present application, the at least two cavities include a first cavity and a second cavity. In the first mode, the steps that the control unit 505 respectively controls at least two heating parts to operate include: respectively controlling the at least two heating parts to operate, and the temperature value of the first cavity is greater than or equal to the difference between a first target temperature value and a first threshold, and is less than or equal to the sum of the first target temperature value and the first threshold; and the temperature value of the second cavity is greater than or equal to the difference between a second target temperature value and a second threshold, and is less than or equal to the sum of the second target temperature value and the second threshold.

In the embodiment, the at least two cavities include the first cavity and the second cavity. In the first mode, respectively controlling at least two heating parts to operate include: respectively controlling the at least two heating parts to operate, and at least one heating part supplies heat to the first cavity, and thus the temperature value of the first cavity reaches the first target temperature value, and remains within a range which is greater than or equal to the difference between the first target temperature value and the first threshold, and is less than or equal to the sum of the first target temperature value and the first threshold; controlling at least one heating part to supply heat to the second cavity, and the temperature value of the second cavity reaches the second target temperature value and remains within a range which is greater than or equal to the difference between the second target temperature value and the second threshold, and is less than or equal to the sum of the second target temperature value and the second threshold. In the case that the cavity partition plate is inserted into the cooking cavity, different cooking temperatures of at least two cavities are achieved, and thus the cooking for different food ingredients is achieved. In the case that the cavity partition plate is not inserted into the cooking cavity, different degrees of baking on both sides of the food ingredients can be achieved, and this further adapts to the cooking of different food ingredients.

The first target temperature value and the second target temperature value are different, and the heating temperatures and heating duration of at least two heating parts are the same or different. Therefore, in the first mode, at least two heating parts can heat at different heating temperatures and different heating duration, or operate at different heating temperatures and at the same heating duration, or operate at the same heating temperature and at different heating duration, or operate at the same heating temperature and at the same heating duration.

In one embodiment, the specific numeric values of the first target temperature value and the second target temperature value are set based on actual cooked dishes.

In a specific application, a user can achieve independent temperature control of divided cavities through the cavity partition plate. When the cavity partition plate is not used, the user can set upper and lower cooking temperatures separately to make a dish. For example, when egg tarts are cooked, the upper baking temperature requirement is 200° C., and the lower baking temperature requirement is 180° C., which can be set separately.

The first target temperature value input by a user is received, then a first temperature range (e.g., the first target temperature value±the first threshold) is determined, and the corresponding heating part is controlled to operate according to the first temperature range; the second target temperature value input by a user is received, then a second temperature range (e.g. the second target temperature value±the second threshold) is determined, and the corresponding heating part is controlled to operate according to the second temperature range.

It can be understood that the first temperature range is obtained by fluctuating the first target temperature value up and down, and the fluctuating temperature range (such as the first threshold) can be from 0° C. to 3° C.; the second temperature range is obtained by fluctuating the second target temperature value up and down, and the fluctuating temperature range (e.g. second threshold) can be from 0° C. to 3° C.

According to some embodiments of the present application, in the first mode, the steps that the control unit 505 respectively controls at least two heating parts to operate include: acquiring the temperature value of the first cavity and the temperature value of the second cavity; in the case that the temperature value of the first cavity is greater than or equal to the first target temperature value and the temperature value of the second cavity is greater than or equal to the second target temperature value, controlling the heating part corresponding to the first cavity to operate at a first on-off ratio, and the temperature value of the first cavity is greater than or equal to the difference between the first target temperature value and the first threshold, and is less than or equal to the sum of the first target temperature value and the first threshold; controlling the heating part corresponding to the second cavity to operate at a second on-off ratio, and the temperature value of the second cavity is greater than or equal to the difference between the second target temperature value and the second threshold, and is less than or equal to the sum of the second target temperature value and the second threshold.

In the embodiment, when at least one heating part supplies heat to the first cavity, the temperature value of the first cavity continuously increases until it reaches the first target temperature value. When the temperature value of the first cavity reaches the first target temperature value, the heating part corresponding to the first cavity is controlled to operate at the first on-off ratio, and the temperature value inside the first cavity is maintained within a range which is greater than or equal to the difference between the first target temperature value and the first threshold, and is less than or equal to the sum of the first target temperature value and the first threshold, and the temperature value inside the first cavity tends to be stable, and thus stable baking for the food ingredients is achieved. Correspondingly, when at least one heating part supplies heat to the second cavity, the temperature value of the second cavity continuously increases until it reaches the second target temperature value. When the temperature value of the second cavity reaches the second target temperature value, the heating part corresponding to the second cavity is controlled to operate at the second on-off ratio, and the temperature value inside the second cavity is maintained within a range which is greater than or equal to the difference between the second target temperature value and the second threshold, and is less than or equal to the sum of the second target temperature value and the second threshold, and the temperature value inside the second cavity tends to be stable, and then stable baking for the food ingredients is achieved.

It is understandable that in the case that the cavity partition plate is provided inside the cooking cavity, the cavity partition plate divides the cooking cavity into the first cavity and the second cavity. The first cavity and the second cavity can achieve independence by the separation of the cavity partition plate, and furthermore, the temperature influence between them is relatively small, and classified baking for different food ingredients can be better achieved.

According to some embodiments of the present application, the cooking appliance further includes a baking pan. When the baking pan is provided in the cooking cavity, the baking pan divides the cooking cavity into a first cavity and a second cavity. In the first mode, the steps that the control unit 505 respectively controls at least two heating parts to operate include: in the case that the temperature value of the first cavity is greater than or equal to the first target temperature value and the temperature value of the second cavity is less than the difference between the second target temperature value and the second threshold, controlling the heating part corresponding to the first cavity to operate at a third on-off ratio, and controlling the heating part corresponding to the second cavity to operate at a fourth on-off ratio; and the third on-off ratio is less than the first on-off ratio, and the fourth on-off ratio is greater than or equal to the second on-off ratio.

In the embodiment, the cooking appliance further includes the baking pan, which is provided inside the cooking cavity and can divide the cooking cavity into the first cavity and the second cavity. At least two heating parts supply heat to the first cavity and the second cavity respectively, and thus this enables baking the top surface and the bottom surface of the food ingredients on the baking pan to different degrees, and thus different cooking effects are achieved. And in the first mode, that is, in an independent control mode of the first cavity and the second cavity, the operating temperatures of at least two heating parts are different, and thus the temperature rise speeds of the first cavity and the second cavity are different, in the case that the temperature value of one of the first cavity and the second cavity reaches the target temperature value while the temperature of the other cavity is still relatively low, for example, in the case that the temperature value of the first cavity is greater than or equal to the first target temperature value and the temperature value of the second cavity is less than the difference between the second target temperature value and the second threshold, the on-off ratio of the heating part corresponding to the second cavity is increased to make the heating part corresponding to the second cavity operate at the fourth on-off ratio, and this further makes the temperature of the second cavity rise rapidly. At the same time, since the heat will be transferred to the first cavity, in order to avoid an excessively high temperature in the first cavity, the on-off ratio of the heating part corresponding to the first cavity is reduced to make the first cavity operate at the third on-off ratio, and this further makes the temperature of the second cavity rise quickly without causing the occurrence of the circumstance of an excessively high temperature value of the first cavity.

The first cavity is located on the top of the second cavity.

According to some embodiments of the present application, the third on-off ratio is less than or equal to ½ of the first on-off ratio.

In the embodiment, the third on-off ratio is less than or equal to ½ of the first on-off ratio, to avoid the occurrence of the circumstance of excessively rapid temperature rise of the temperature value in the first cavity.

According to some embodiments of the present application, the receiving unit 501 is further configured to receive input for the first target temperature value and the second target temperature value, or identify food ingredient information inside the cooking cavity, and determine the first target temperature value and the second target temperature value based on the food ingredient information.

In the embodiment, for the first target temperature value and the second target temperature value, they can be actively input by a user or determined based on different food ingredient information.

In one embodiment, the food ingredient information includes the type and weight of the food ingredient. The cooking appliance can store heating temperatures and heating duration corresponding to different food ingredients and different weights in advance.

An identification unit is provided inside the cooking appliance, and configured to recognize food ingredient information.

According to some embodiments of the present application, the temperature control mode further includes a second mode; in the case that the second input is the second mode, the control unit 505 controls at least two heating parts to operate at a third target temperature value.

In the embodiment, the temperature control mode further includes the second mode. In the case that the switch is not triggered, the cavity partition plate is not installed in the cooking cavity, or the cavity partition plate is not installed in place, then the second input from the user is received to conduct second confirmation of the temperature control mode. In the case that the second input is the second mode, it means that the cavity partition plate is not placed, and food ingredients are cooked through a large cooking cavity, and then, at least two heating parts are controlled to operate at the third target temperature value, that is, the heating temperatures and heating parameters of at least two heating parts are made to be the same, and thus synchronous baking of the food ingredients by at least two heating parts is realized, and the cooking efficiency is improved.

It is understandable that the third target temperature value is set based on actual cooked dishes.

According to some embodiments of the present application, in the case that the switch is not triggered, the cavity partition plate is separated from the cooking cavity, or the cavity partition plate is not installed in place.

In some embodiments, in the case that the switch is not triggered, it is possible that the cavity partition plate is separated from the cooking cavity, or the cavity partition plate is not installed in place, and in either case of the two cases, it is possible to enter the first mode or the second mode according to the second input. In the first mode, independent control of at least two heating parts is realized, and then different degrees of cooking are achieved. In the second mode, synchronous control of at least two heating parts is realized to improve cooking efficiency.

According to some embodiments of the present application, the control unit 505 is further configured to control at least two heating parts to preheat at a corresponding fourth target temperature value.

In the embodiment, the control unit 505 of a cooking appliance is further configured to control at least two heating parts to preheat at the corresponding fourth target temperature value, thus improving the cooking effect of the food ingredients.

It can be understood that the fourth target temperature value can be a heating temperature manually input by a user or a heating temperature automatically confirmed by the cooking appliance.

As shown in FIG. 4, FIG. 5 and FIG. 6, according to an embodiment of the present application, a cooking appliance is further provided, and the cooking appliance includes a cooking cavity 1, a switch 2, a cavity partition plate 3 and at least two heating parts 4. The cavity partition plate 3 is detachably connected to the cooking cavity 1. In the case that the cavity partition plate 3 is connected to the cooking cavity 1, the cavity partition plate 3 can trigger the switch 2. The cavity partition plate 3 divides the cooking cavity 1 into at least two cavities 10, and the at least two heating parts 4 supply heat to the at least two cavities 10 respectively. In addition, it further includes the control device 5 provided in any of the above items.

The cooking appliance provided by the present application includes a cooking cavity 1, a switch 2, a cavity partition plate 3 and at least two heating parts 4. The cavity partition plate 3 is detachably connected to the cooking cavity 1. In the case that the cavity partition plate 3 is installed inside the cooking cavity 1, the cavity partition plate 3 divides the cooking cavity 1 into at least two cavities 10, and then the cooking of different food ingredients is achieved respectively through the at least two cavities 10, and thus the cooking efficiency is improved. In the case that the cavity partition plate 3 is separated from the cooking cavity 1, the volume of the cooking cavity 1 is relatively large, which enables the cooking of food ingredients with a relatively large volume, at the same time, the at least two heating parts 4 can be configured to cook one type of food ingredient simultaneously, and this improves cooking effect. In addition, in the case that the cavity partition plate 3 is installed inside the cooking cavity 1, the cavity partition plate 3 can trigger the switch 2, and then the control device 5 controls the at least two cavities 10 to enter the first mode in the case that the switch 2 is triggered, and then the independent control of at least two cavities 10 is achieved. In the case that the switch 2 is not triggered, it means that the cavity partition plate 3 is not placed in place and thus the switch 2 is not triggered, or the cavity partition plate 3 is not placed in the cooking cavity 1, and the inside of the cooking appliance is a large cooking cavity 1, in this case, the second input for the temperature control mode is received, if the second input is the first mode, in the case that the cavity partition plate 3 is not placed and the cavity partition plate 3 is not placed in place, the independent control of at least two heating parts 4 can further be achieved. Furthermore, in the case that the cavity partition plate 3 is not placed, different baking on both sides of the food ingredients is achieved, and in the case that the cavity partition plate 3 is not placed in place, the independent control of the food ingredients in at least two cavities 10 is achieved, and thus the cooking effect is improved. The cooking appliance provided in the present application can achieve the independent control of at least two heating parts 4 regardless of whether the cavity partition plate 3 is installed inside the cooking cavity 1.

It should be noted that in the case that the switch 2 is not triggered, for example, the cavity partition plate 3 is not placed in the cooking cavity 1, and a baking pan and/or grill are put into the cooking cavity 1, the switch 2 cannot be triggered when the food ingredients on the baking pan and/or grill are cooked. In the case of entering the first mode, the upper and lower sides of the food ingredients on the baking pan can be baked to different degrees, and this improves the cooking effect.

It is understandable that the number of the cavity partition plates 3 is one or more.

In a specific application, the switch 2 includes a micro switch. In the case that the cavity partition plate 3 is placed inside the cooking cavity 1, the cavity partition plate 3 triggers the micro switch.

In a specific application, the first mode is an independent control mode, and the second mode is a non-independent control mode.

According to some embodiments of the present application, in the case that the switch 2 is not triggered, the cavity partition plate 3 is separated from the cooking cavity 1 or the cavity partition plate 3 is not installed in place.

In the embodiment, in the case that the switch 2 is not triggered, it is possible that the cavity partition plate 3 is separated from the cooking cavity 1, or the cavity partition plate 3 is not installed in place. In either case of the two cases, it is possible to achieve entering the first mode or the second mode according to the second input. In the first mode, the independent control of at least two heating parts 4 can be realized, and then different degrees of cooking are achieved. In the second mode, synchronous control of at least two heating parts 4 is realized to improve cooking efficiency.

As shown in FIG. 5, according to some embodiments of the present application, the at least two cavities 10 include a first cavity 102 and a second cavity 104, which are distributed along a vertical direction; and/or, the cooking appliance further includes a baking pan 30, which is detachably arranged inside the cooking cavity 1 and divides the cooking cavity 1 into the first cavity 102 and the second cavity 104.

In the embodiment, the at least two cavities 10 include the first cavity 102 and the second cavity 104, which are distributed along the vertical direction, and this reduces the occupation of the horizontal space of the kitchen by the cooking appliance and facilitates the storage of the cooking appliance. The cooking appliance further includes the baking pan 30, which divides the cooking cavity 1 into the first cavity 102 and the second cavity 104. The baking pan 30 can carry the food ingredients and further achieves the cooking of the food ingredients.

In one embodiment, in the case that the switch 2 is not triggered, for example, the cavity partition plate 3 is not placed in the cooking cavity 1, and a baking pan 30 and/or grill are put into the cooking cavity 1, the switch 2 cannot be triggered when the food ingredients on the baking pan 30 and/or grill are cooked. In the case of entering the first mode, the upper and lower sides of the food ingredients on the baking pan 30 can be baked to different degrees, and this improves the cooking effect.

As shown in FIG. 6, according to some embodiments of the present application, the heating part 4 includes a hot air assembly 40, and at least two hot air assemblies 40 are configured to deliver hot air into the cooking cavity 1.

In the embodiment, the heating part 4 includes the hot air assembly 40, and the hot air assembly 40 can deliver hot air into the cooking cavity 1, and this further achieves air frying of the food ingredients.

In one embodiment, the cooking appliance includes at least two hot air assemblies 40, in the case that the cavity partition plate 3 is arranged inside the cooking cavity 1, the at least two hot air assemblies 40 respectively deliver hot air to at least two cavity bodies 10.

In one embodiment, the hot air assembly 40 includes a fan and a heating tube, and the fan is configured to transfer the heat of the heating tube to the cooking cavity 1, to achieve the cooking of the food ingredients.

According to some embodiments of the present application, the heating part 4 includes at least two heating tubes for radiating heat into the cooking cavity 1.

According to some embodiments of the present application, the heating part 4 further includes at least one microwave generating part 42 configured to feed microwaves into the cooking cavity 1.

In the embodiment, the heating part 4 further includes the microwave generating part 42 configured to feeding microwaves into the cooking cavity 1, and this further achieves microwave cooking of the food ingredients inside the cooking cavity 1.

It is understandable that the cooking appliance provided in the present application has both the hot air cooking function and the microwave cooking function, and this enhances cooking selectivity and cooking effect.

In a specific application, the number of microwave generating parts 42 is at least two, and the at least two microwave generating parts 42 can correspond to at least two cavity bodies 10 and feed microwaves into the at least two cavity bodies 10 respectively.

In one embodiment, cooking appliances include an oven, an air fryer, an air fryer microwave integrated machine, a microwave oven, etc.

As shown in FIG. 8, according to an embodiment of the present application, an electronic device 6 is further provided, including: a processor 602 and memory 604, and the memory 604 stores programs or instructions which can be executed on the processor 602, when the programs or instructions are executed by the processor 602, the steps of the control method for a cooking appliance provided in any of the above embodiments are achieved. Therefore, the electronic device has all the beneficial effects of the control method for a cooking appliance, which will not be repeated here.

According to an embodiment of the present application, a computer-readable storage medium is further provided, in which programs or instructions are stored, when the programs or instructions are executed by a processor, the steps of the control method for a cooking appliance provided in any of the above embodiments is implemented. Therefore, the computer-readable storage medium has all the beneficial effects of the control method for a cooking appliance, which will not be repeated here.

The methodologies described herein may be implemented by various means depending upon applications according to particular features and/or examples. For example, such methodologies may be implemented in hardware, firmware, and/or combinations thereof, along with software. In a hardware implementation, for example, a processor may be implemented within one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, electronic devices, other devices units designed to perform the functions described herein, and/or combinations thereof.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media, or electrical signals transmitted through a wire.

In the present application, the term of “multiple” refers to two or more than two, unless otherwise clearly defined. The terms “install”, “connected with”, “connected to”, “fix” and the like should be understood in a broad sense, for example, the term “connected to” can be a fixed connection, a detachable connection, or an integral connection; the term “connected with” can be a direct connection, or an indirect connection through an intermediate medium. The specific meanings of the above terms in the present application can be understood according to the specific situations.

In the specification of the present application, the descriptions of the phrases “one embodiment”, “some embodiments” or “specific embodiments” and the like mean that the specific features, structures, materials or characteristics described in combination with the embodiment or example are included in at least one embodiment or example of the present application. In the specification of the present application, the illustrative expressions of the above terms may not necessarily refer to the same embodiments or examples. Moreover, the specific features, structures, materials, or characteristics as described can be combined in any one or more embodiments or examples in a suitable manner.

Described above are only some embodiments of the present application and are not intended to limit the present application. The present application may have various modifications and variations. Any modifications, equivalent substitutions, improvements, etc. made within the spirit and principles of this application shall be included within the scope of protection of this application.

What is claimed is:

1. A control method for a cooking appliance, and the cooking appliance comprises a cooking cavity, a switch, a cavity partition plate and at least two heating parts, the cavity partition plate is detachably connected to the cooking cavity, in the case that the cavity partition plate is connected to the cooking cavity, the cavity partition plate is configured to trigger the switch, the cavity partition plate divides the cooking cavity into at least two cavities, and at least two of the heating parts supply heat to at least two of the cavities respectively, wherein, the control method comprises:
receiving a first input for the cooking appliance;
in response to the first input, acquiring trigger information of the switch;
in the case that the switch is triggered, determining that a temperature control mode of the cooking appliance is a first mode;
in the case that the switch is not triggered, receiving a second input for the temperature control mode; and
in the case that the second input is the first mode, determining that the temperature control mode is the first mode;
wherein, in the first mode, at least two of the heating parts are respectively controlled to operate.

2. The control method for a cooking appliance according to claim 1, wherein, at least two of the cavities comprise a first cavity and a second cavity, in the first mode, the steps of respectively controlling at least two of the heating parts to operate comprise:
respectively controlling at least two of the heating parts to operate, wherein a temperature value of the first cavity is greater than or equal to the difference between a first target temperature value and a first threshold, and is less than or equal to the sum of the first target temperature value and the first threshold; and wherein the temperature value of the second cavity is greater than or equal to the difference between a second target temperature value and a second threshold, and is less than or equal to the sum of the second target temperature value and the second threshold.

3. The control method for a cooking appliance according to claim 2, wherein, in the first mode, the steps of respectively controlling at least two of the heating parts to operate comprise:
acquiring the temperature value of the first cavity and the temperature value of the second cavity;
in the case that the temperature value of the first cavity is greater than or equal to the first target temperature value and the temperature value of the second cavity is greater than or equal to the second target temperature value, controlling the heating part corresponding to the first cavity to operate at a first on-off ratio, wherein the temperature value of the first cavity is greater than or equal to the difference between the first target temperature value and the first threshold, and is less than or equal to the sum of the first target temperature value and the first threshold; and
controlling the heating part corresponding to the second cavity to operate at a second on-off ratio, wherein the temperature value of the second cavity is greater than or equal to the difference between the second target temperature value and the second threshold, and is less than or equal to the sum of the second target temperature value and the second threshold.

4. The control method for a cooking appliance according to claim 3, wherein, the cooking appliance further comprises a baking pan, when the baking pan is provided in the cooking cavity, the baking pan divides the cooking cavity into the first cavity and the second cavity, in the first mode, the steps of respectively controlling at least two of the heating parts to operate comprise:
in the case that the temperature value of the first cavity is greater than or equal to the first target temperature value and the temperature value of the second cavity is less than the difference between the second target temperature value and the second threshold, and
controlling the heating part corresponding to the first cavity to operate at a third on-off ratio, and controlling the heating part corresponding to the second cavity to operate at a fourth on-off ratio;
wherein the third on-off ratio is less than the first on-off ratio, and the fourth on-off ratio is greater than or equal to the second on-off ratio.

5. The control method for a cooking appliance according to claim 4, wherein, the third on-off ratio is less than or equal to 1/2 of the first on-off ratio.

6. The control method for a cooking appliance according to claim 2, further comprising:
receiving input for the first target temperature value and the second target temperature value, or identifying food ingredient information inside the cooking cavity, and determining the first target temperature value and the second target temperature value based on the food ingredient information.

7. The control method for a cooking appliance according to claim 1, wherein, the temperature control mode further comprises a second mode;
in the case that the second input is the second mode, controlling at least two of the heating parts to operate at a third target temperature value.

8. The control method for a cooking appliance according to claim 1, further comprising:
controlling at least two of the heating parts to preheat at a corresponding fourth target temperature value.

9. The control method for a cooking appliance according to claim 1, wherein, in the first mode, the steps of respectively controlling at least two of the heating parts to operate further comprise:
controlling at least two of the heating parts to respectively operate for a first target duration and a second target duration.

10. A control device of a cooking appliance, wherein, the cooking appliance comprises a cooking cavity, a switch, a cavity partition plate and at least two heating parts, the cavity partition plate is detachably connected to the cooking cavity, in the case that the cavity partition plate is connected to the cooking cavity, the cavity partition plate can trigger the switch, the cavity partition plate divides the cooking cavity into at least two cavities, and at least two of the heating parts supply heat to at least two of the cavities respectively; wherein, the control device comprises:
a receiving unit, configured to receive a first input for the cooking appliance;
a responding unit, configured to respond to the first input;
an acquiring unit, configured to acquire a trigger information of the switch;
a determining unit, configured to determine that a temperature control mode of the cooking appliance is a first mode in the case that the switch is triggered; wherein, in the case that the switch is not triggered, the receiving unit is further configured to receive a second input for the temperature control mode; in the case that the second input is the first mode, the determining unit is further configured to determine that the temperature control mode is the first mode; and
a control unit, configured to respectively control at least two of the heating parts to operate in the first mode.

11. A cooking appliance, comprising:
a cooking cavity, a switch, a cavity partition plate and at least two heating parts, wherein, the cavity partition plate is detachably connected to the cooking cavity, in the case that the cavity partition plate is connected to the cooking cavity, the cavity partition plate can trigger the switch, the cavity partition plate divides the cooking cavity into at least two cavities, and at least two of the heating parts supply heat to at least two of the cavities respectively; and
the control device according to claim 10.

12. The cooking appliance according to claim 11, wherein, in the case that the switch is not triggered, the cavity partition plate is separated from the cooking cavity or the cavity partition plate is not installed in place.

13. The cooking appliance according to claim 11, wherein, at least two of the cavities comprise a first cavity and a second cavity, which are distributed along a vertical direction; and/or, the cooking appliance further comprises a baking pan, which is detachably arranged inside the cooking cavity and divides the cooking cavity into a first cavity and a second cavity.

14. The cooking appliance according to claim 11, wherein, the heating part comprises:
a hot air assembly, configured to deliver hot air into the cooking cavity.

15. The cooking appliance according to claim 14, wherein, the heating part further comprises:
a microwave generating part, configured to feed microwaves into the cooking cavity.

16. An electronic device, comprising: a processor and a memory, wherein the memory stores programs or instructions which can be executed on the processor, when the programs or instructions are executed by the processor, the steps of the control method for a cooking appliance provided in claim 1 are achieved.

17. A computer-readable storage medium, in which programs or instructions are stored, wherein, when the programs or instructions are executed by a processor, the control method for a cooking appliance provided in claim 1 is implemented.
